(19) United States
(12) Patent Application Publication
(10) Pub. No.: US 2024/0406618 A1
(43) Pub. Date: Dec. 5, 2024

(54) ACOUSTIC DEVICE

(71) Applicant: Shenzhen Dancing Future Technology Ltd., Shenzhen (CN)

(72) Inventors: Chuanbo WANG, Shenzhen (CN); Hongguo DENG, Shenzhen (CN); Haoquian LI, Shenzhen (CN)

(21) Appl. No.: 18/806,569

(22) Filed: Aug. 15, 2024

Related U.S. Application Data
(63) Continuation of application No. PCT/CN2022/126079, filed on Oct. 19, 2022.

(30) Foreign Application Priority Data
Oct. 9, 2022 (CN) 202211225706.9

(51) Int. Cl. H04R 1/34; H04R 1/02; H04R 1/10; H04R 1/28

(52) U.S. Cl. CPC H04R 1/347; H04R 1/023; H04R 1/1008; H04R 1/1041; H04R 1/1075; H04R 1/2834; H04R 2460/07

(57) ABSTRACT

An acoustic device is provided, including a housing, and a sound source disposed in the housing, where the housing is provided with a sound outlet hole and a reverse-phase sound hole in different surfaces of the housing, and sounds emitted from the sound outlet hole and from the reverse-phase sound hole are opposite in phase and identical in amplitude; a first sound cavity is formed between a front end of the sound source and the sound outlet hole, and a second sound cavity is formed between a rear end of the sound source and the reverse-phase sound hole; and the first sound cavity is communicated with the second sound cavity through an acoustic dipole tube.

### CROSS-REFERENCE TO RELATED APPLICATIONS

The present application is a continuation of International Application No. PCT/CN2022/126079, filed on Oct. 19, 2022, which claims priority to Chinese Patent Application No. 202211225706.9, filed with China National Intellectual Property Administration on Oct. 9, 2022, entitled with “Acoustic device”. The disclosures of the aforementioned applications are hereby incorporated by reference in their entireties.

### TECHNICAL FIELD

The present disclosure relates to the field of electroacoustic technology and, in particular, to an acoustic device.

### BACKGROUND

In the design of existing audio products, such as eyeglasses and suspended headphones, a sound outlet is far away from an ear canal entrance point (EEP, Ear canal Entrance Point, in Standard ITU-T P.57, issued by International Telecommunication Union (ITU) Telecommunication Standardization Sector). When an audio device is playing at a high volume, there is a loud sound leakage to the outside, which affects the outside, or leaks the privacy of a user.

### SUMMARY

An object of the present disclosure is to overcome deficiencies of the prior art and to provide an acoustic device.

In order to achieve the above object, the following technical solutions are used in the present disclosure.

An acoustic device, including a housing and a sound source disposed in the housing, where the housing is provided with a sound outlet hole and a reverse-phase sound hole on different surfaces of the housing; sounds emitted from the sound outlet hole and from the reverse-phase sound hole are opposite in phase and identical in amplitude; a first sound cavity is formed between a front end of the sound source and the sound outlet hole, and a second sound cavity is formed between a rear end of the sound source and the reverse-phase sound hole; and the first sound cavity is communicated with the second sound cavity through an acoustic dipole tube.

Further technical solution is as follows: the sound source radiates sound signals to a front side and a rear side of the sound source.

Further technical solution is as follows: a spatial coordinate system is established with Ear canal Entrance Point, EEP, in Standard ITU-T P.57, as an origin point, the EEP is taken as the origin point 0, a positive semi-axis of X axis that is perpendicular to an ear outwardly is provided, a positive semi-axis of Y axis that is perpendicular to the ear forwardly is provided, and a positive semi-axis of Z axis that is vertical upwardly is provided; when the acoustic device is worn, the sound outlet hole is located in an area of (0 mm, −12.2 mm, −5.2 mm), (15.3 mm, 3.2 mm, 13.3 mm) and (3 mm, 10 mm, −10 mm) in the coordinate system, and the reverse-phase sound hole is located in an area of (5 mm, −22 mm, −3.2 mm), (27.3 mm, 15 mm, 18 mm) and (5 mm, −15 mm, 12 mm) in the coordinate system.

Further technical solution is as follows: a spatial coordinate system is established with Ear reference Point, EPR, in Standard ITU-T P.57, as an origin point, the EPR is taken as the origin point 0, a positive semi-axis of X axis that is perpendicular to an ear outwardly is provided, a positive semi-axis of Y axis that is perpendicular to the ear forwardly is provided, and a positive semi-axis of Z axis that is vertical upwardly is provided; when the acoustic device is worn, the sound outlet hole is located in an area of (0 mm, −12.2 mm, −5.2 mm), (15.3 mm, 3.2 mm, 13.3 mm) and (3 mm, 10 mm, −10 mm) in the coordinate system, and the reverse-phase sound hole is located in an area of (5 mm, −22 mm, −3.2 mm), (27.3 mm, 15 mm, 18 mm) and (5 mm, −15 mm, 12 mm) in the coordinate system.

Further technical solution is as follows: a set angle is formed between a sound outlet direction of the sound outlet hole and a sound outlet direction of the reverse-phase sound hole, and the set angle is 90° to 180°.

Further technical solution is as follows: volumes of the first sound cavity and the second sound cavity are greater than 0.8 cm³, and the volume of the first sound cavity is 0.4 to 6 times that of the second sound cavity.

Further technical solution is as follows: the sound outlet hole and the reverse-phase sound hole are both provided with acoustic mesh clothes, respectively, and an acoustic impedance of the sound outlet hole and the attached acoustic mesh cloth, and an acoustic impedance of the reverse-phase sound hole and the attached acoustic mesh cloth are less than or equal to 9*10⁷ Pa·s/m³.

Further technical solution is as follows: a cross-sectional area of the sound outlet hole is 20% to 35% of an area of a vibrating diaphragm of the sound source, and a cross-sectional area of the reverse-phase sound hole is 15% to 20% of the area of the vibrating diaphragm of the sound source.

Further technical solution is as follow: areas of the sound outlet hole and the reverse-phase sound hole are greater than or equal to 4 mm², and the area of the sound outlet hole is 0.4 to 2.5 times that of the reverse-phase sound hole.

Further technical solution is as follows: the cross section area of the acoustic dipole tube is more than or equal to 2 mm²; and the length of the acoustic dipole tube is more than or equal to 2 mm and less than or equal to 25 mm.

Further technical solution is as follow: the acoustic dipole tube is provided with an acoustic mesh cloth at a position where the first sound cavity or the second sound cavity is communicated with the acoustic dipole tube.

Further technical solution is as follows: the sound source is a single-vibrating diaphragm loudspeaker; the single-vibrating diaphragm loudspeaker is provided with a first vibrating diaphragm; the first sound cavity is formed between the first vibrating diaphragm and an inner wall of the housing; and the second sound cavity is formed between a rear side of the single-vibrating diaphragm loudspeaker and an inner wall of the housing.

Further technical solution is as follows: the sound source is a dual-vibrating diaphragm loudspeaker; the dual-vibrating diaphragm loudspeaker is provided with a first vibrating diaphragm and a second vibrating diaphragm; the first sound cavity is formed between the first vibrating diaphragm and an inner wall of the housing; and the second sound cavity is formed between the second vibrating and an inner wall of the housing.

Further technical solution is as follows: the sound source includes a single-vibrating diaphragm loudspeaker and a passive vibrating diaphragm; the single-vibrating diaphragm loudspeaker is provided with a first vibrating diaphragm; the first sound cavity is formed between the first vibrating diaphragm and an inner wall of the housing; and the second sound cavity is formed between the passive vibrating diaphragm and an inner wall of the housing.

Further technical solution is as follows: the passive vibrating diaphragm and a rear side of the single-vibrating diaphragm loudspeaker form a first closed sound cavity; and a volume of the first closed sound cavity is less than 18 cm³.

Further technical solution is as follow: the sound source is a loudspeaker assembly; the loudspeaker assembly includes at least one pair of single-vibrating diaphragm loudspeakers; the single-vibrating diaphragm loudspeakers are disposed back to back; the single-vibrating diaphragm loudspeakers are provided with first vibrating diaphragms, respectively; the first sound cavity is formed between the first vibrating diaphragm of one single-vibrating diaphragm loudspeaker and an inner wall of the housing, and the second sound cavity is formed between the first vibrating diaphragm of the other single-vibrating diaphragm loudspeaker and an inner wall of the housing.

Further technical solution is as follows: a second closed sound cavity is formed between rear sides of the pair of single-vibrating diaphragm loudspeakers; and a volume of the second closed sound cavity is less than 18 cm³.

Further technical solution is as follows: the sound source is provided with a vibrating diaphragm, and a distance between a center of two ends of the acoustic dipole tube and a center of the vibrating diaphragm is not more than 25 mm.

Further technical solution is as follows: a distance between a center of two ends of the acoustic dipole tube and a center of the sound outlet hole and a distance between the center of two ends of the acoustic dipole tube and a center of the reverse-phase sound hole are both not more than 30 mm.

The beneficial effects of the present disclosure compared with the prior art are as below. According to the present disclosure, the first sound cavity is disposed between the sound outlet hole and the sound source, the second sound cavity is disposed between the reverse-phase sound hole and the rear side of the sound source, and the first sound cavity is communicated with the second sound cavity through the dipole tube, such that sounds with identical amplitudes and opposite phases are coupled inside the acoustic device, and the size of the acoustic dipole tube and acoustic impedances provided on the acoustic dipole tube are adjusted so as to achieve the purpose of adjusting the size of sound coupling, thereby effectively inhibiting sound leakage.

The above description is only an overview of the technical solutions of the present disclosure. In order to more clearly understand the technical means of the present disclosure, the present disclosure may be implemented according to contents of the specification, and in order to make the above and other objects, features and advantages of the present disclosure more obvious and understandable, the following embodiments are provided for example, and the detailed description is as below.

### BRIEF DESCRIPTION OF DRAWINGS

FIG. 1 is a coordinate system of an acoustic device of the present disclosure with EEP as an origin point.

FIG. 2 is a sectional view along line B-B of FIG. 1.

FIG. 3 is a coordinate system of an acoustic device of the present disclosure with ERP as an origin point.

FIG. 4 is a sectional view along line A-A of FIG. 3.

FIG. 5 is a sectional view of a single-vibrating diaphragm sound source of an acoustic device of the present disclosure.

FIG. 6 is a sectional view of a dual-vibrating diaphragm sound source of an acoustic device of the present disclosure.

FIG. 7 is a sectional view of a single-vibrating diaphragm sound source and a passive vibrating diaphragm of an acoustic device according to the present disclosure.

FIG. 8 is a cross-sectional view of a loudspeaker assembly of an acoustic device of the present disclosure.

FIG. 9 is a sound-leakage frequency response curve of an acoustic device of the present disclosure.

FIG. 10 is a frequency response curve of an acoustic device of the present disclosure.

### DESCRIPTION OF EMBODIMENTS

To make the objectives, technical solutions, and advantages of the present disclosure more clearly understood, the present disclosure will be described in detail below with reference to the drawings and the specific embodiments.

The technical solutions in embodiments of the present disclosure will be described clearly and comprehensively below with reference to the drawings of the embodiments of the present disclosure. Apparently, the described embodiments are merely a part rather than all embodiments of the present disclosure. All other embodiments obtained by persons of ordinary skill in the art based on embodiments of the present disclosure without creative effort shall fall within the protection scope of the present disclosure.

In the description of the present disclosure, it should be understood that the used terms “center”, “longitudinal”, “lateral”, “length”, “width”, “thickness”, “upper”, “lower”, “front”, “back”, “left”, “right”, “vertical”, “horizontal”, “top”, “bottom”, “inner”, “outer”, “clockwise”, “counterclockwise” and the like indicate the orientation or positional relationship based on the orientation or positional relationship shown in the drawings. It is only for the convenience of describing the present disclosure and simplifying the description, but not for indicating or implying that the locations or elements referred to must have a specific orientation, and be constructed and operated in a specific orientation, therefore, it cannot be understood as limiting the present disclosure.

Furthermore, the terms “first” and “second” are only used for descriptive purposes, and it cannot be understood as indicating or implying relative importance or as implying the numbers of the indicated technical features. Thus, the features defined with “first” or “second” may explicitly or implicitly include one or more of the features. In the description of the present disclosure, “a plurality of” means at least two, unless otherwise clearly defined.

In the present disclosure, unless otherwise clearly specified and defined, the terms “mounted”, “connecting”, “connected” and “fixed” should be understood broadly. For example, it can be a connection, a detachable connection, or an integral connection; it can be a mechanical connection, an electrical connection; it can be a direct connection, an indirect connection through an intermediary, an internal communication between two components, or an interactive relationship between two components. For those of ordinary skill in the art, the specific meanings of the above terms in the present disclosure can be understood according to specific situations.

In the present disclosure, unless otherwise clearly specified and defined, the description of a first feature being “over” or “under” a second feature may include the first and second features being in direct contact, or the first and second features being in non-direct contact through another feature between them. Also, the description of a first feature being “on”, “above”, and “on top of” a second feature include the first feature being directly above and diagonally above the second feature, or simply means that the first feature is at a higher level than the second feature. The description of a first feature being “under”, “below” and “on the bottom of” a second feature include the first feature being directly below and diagonally below the second feature, or simply means that the first feature is at a lower level than the second feature.

In the description of this specification, reference to the terms “one embodiment”, “some embodiments”, “an example”, “a specific example”, or “some examples” means that particular features, structures, materials, or characteristics described in connection with this embodiment or example are included in at least one embodiment or example of the present disclosure. In this specification, schematic expressions of the above terms should not be understood as necessarily referring to the same embodiment or example. Moreover, the particular features, structures, materials, or characteristics described may be combined in any one or more embodiments or examples in a suitable manner. In addition, various embodiments or examples described in this specification may be incorporated and combined by those of ordinary skill in the art.

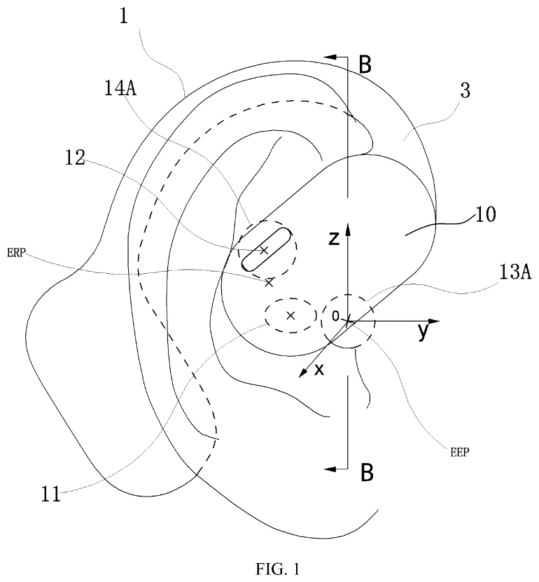

FIGS. 1 to 10 are drawings of the present disclosure.

This embodiment provides an acoustic device, as shown in FIGS. 1 to 4. The position of an ear canal entrance point 4 (EEP, Ear canal Entrance Point) and the position of an ear reference point (ERP, Ear reference Point) are defined in Standard ITU-T P.57 issued by International Telecommunication Union (ITU) Telecommunication Standardization Sector.

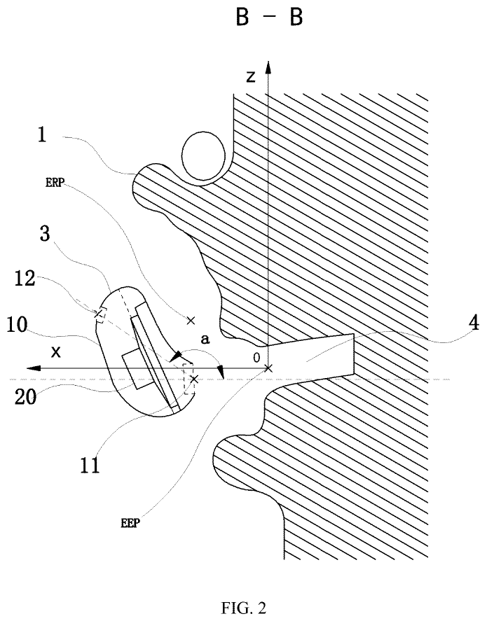

As shown in FIGS. 1 to 2, EEP is taken as an origin point 0, an axis facing outside of the ear from EEP is taken as a positive semi-axis of X axis, an axis facing forwards from EEP is taken as a positive semi-axis of Y axis, and an axis facing upwards from EEP is taken as a positive semi-axis of Z axis, thereby forming a first coordinate system. In the spatial coordinate system with EEP as the origin point, when an acoustic device 3 is worn on the ear 1, the coordinate (x, y, z) of the center point of a sound outlet hole 11 is located in a spatial area 13A enclosed by (0 mm, −12.2 mm, −5.2 mm), (15.3 mm, 3.2 mm, 13.3 mm), and (3 mm, 10 mm, −10 mm). The coordinate (x, y, z) of the center point of a reverse-phase sound hole 12 is located in a spatial area 14A enclosed by (5 mm, −22 mm, −3.2 mm), (27.3 mm, 15 mm, 18 mm) and (5 mm, −15 mm, 12 mm).

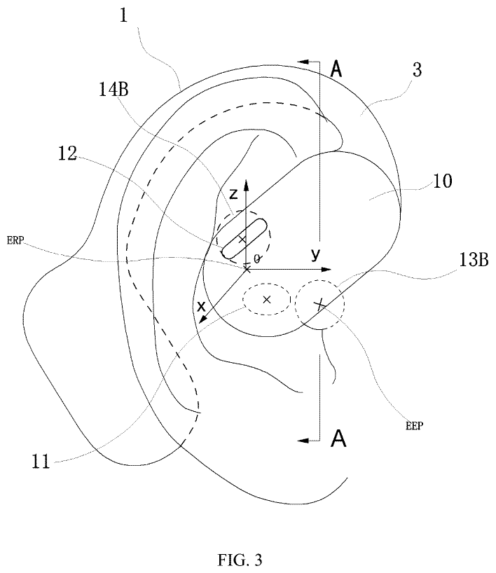

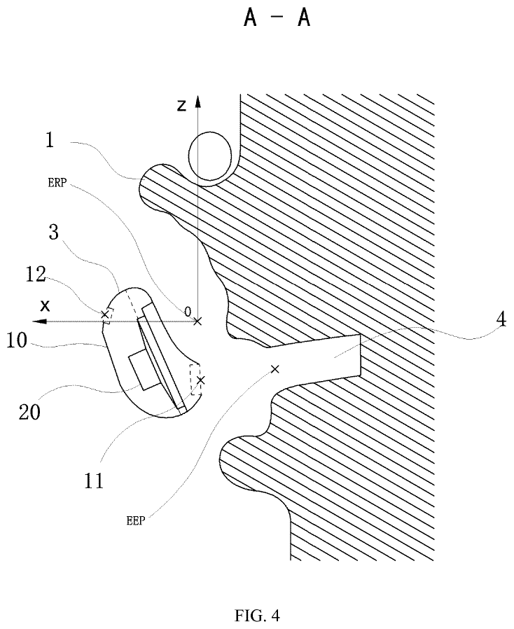

As shown in FIGS. 3 to 4, similarly, the present disclosure refers to the ear reference point (ERP, Ear reference Point) in Standard ITU-T P.57 as an origin point to establish a second spatial coordinate system. As shown in FIGS. 3 to 4, ERP is taken as an origin point 0, an axis facing outside of the ear from ERP is taken as a positive semi-axis of X axis, an axis facing forwards from ERP is taken as a positive semi-axis of Y axis, and an axis facing upwards from ERP is taken as a positive semi-axis of Z axis. In the spatial coordinate system with ERP as the origin point, when the acoustic device 3 is worn on the ear 1, the coordinate (x, y, z) of the center point of the sound outlet hole 11 is located in a spatial area 13B enclosed by (0 mm, −12.2 mm, −5.2 mm), (15.3 mm, 3.2 mm, 13.3 mm), and (3 mm, 10 mm, −10 mm), and the coordinate (x, y, z) of the center point of the reverse-phase sound hole 12 is located in a spatial area 14B enclosed by (5 mm, −22 mm, −3.2 mm), (27.3 mm, 15 mm, 18 mm) and (5 mm, −15 mm, 12 mm).

The acoustic device 3 is provided with a wearing structure, so that the sound outlet hole 11 and the reverse-phase sound hole 12 can be located in the above spatial areas 13A and 14A, and the above spatial areas 13B and 14B. After the sound outlet hole 11 and the reverse-phase sound hole 12 are located in the above spatial areas, sounds emitted from the sound outlet hole 11 and from the reverse-phase sound hole 12 are opposite in phase and identical in amplitude, so that the acoustic device 3 can better reduce the sound leakage to the outside of the ear and enhance the sound energy at the in-ear end.

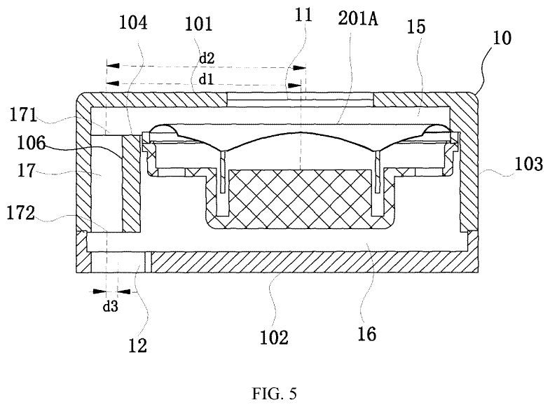

In a specific structure of the acoustic device 3, as shown in FIGS. 5 to 7, the acoustic device 3 includes a housing 10, and a sound source 20 disposed inside the housing 10. The sound source 20 may radiate sound signals to a front side and a rear side of the sound source. The housing 10 is provided with a sound outlet hole 11 and a reverse-phase sound hole 12 on different surfaces of the housing 10, where a sound signal radiated forward from the sound source 20 is transmitted out through the sound outlet hole 11, and a sound signal radiated backward from the sound source 20 is transmitted out through the reverse-phase sound hole 12. Sounds emitted from the sound outlet hole 11 and from the sound outlet hole 12 are opposite in phase and identical in amplitude. A first sound cavity 15 is formed between the front side of the sound source 20 and the sound outlet hole 11, and a second sound cavity 16 is formed between the rear side of the sound source 20 and the reverse-phase sound hole 12. The first sound cavity 15 and the second sound cavity 16 are communicated with each other through an acoustic dipole tube 17. The first sound cavity 15 and the second sound cavity 16 are accommodating cavities, and the cross-sectional areas of the first sound cavity 15 and the second sound cavity 16 are both larger than those of the sound outlet hole 11 and the reverse-phase sound hole 12. Sounds emitted from the sound source 20 pass through the first sound cavity 15 and the second sound cavity 16 to filter high frequency, so as to improve the low frequency characteristics, thereby making sounds emitted more mellow.

Sound emitted from the sound outlet hole 11 and the sound emitted from the reverse-phase sound hole 12 are opposite in phase and identical in amplitude, and a set angle is formed between a sound outlet direction of the sound outlet hole 11 and a sound outlet direction of the reverse-phase sound hole 12 (in some embodiments, as shown in FIG. 2, the angle a is a set angle having a size of 90° to 180°). In this embodiment, the sound outlet hole 11 and the reverse-phase sound hole 12 are provided in two opposite surfaces of the housing 10, so that sounds emitted from the reverse-phase sound hole 12 towards the outside can be offset each other to avoid sound leakage, and sounds towards the inside of the ear (i.e., the inside of the ear canal) are not offset each other or the offset energy is limited. Therefore, when the acoustic device is worn, a wearer can hear sound, but the sound cannot be heard from outside, and thus the acoustic device has the function of preventing sound from leaking out.

The volumes of the first sound cavity 15 and the second sound cavity 16 affect the sound quality effect, therefore, in some embodiments, the volumes of the first sound cavity 15 and the second sound cavity 16 are larger than 0.8 cm³, and the volume of the first sound cavity 15 is 0.4 to 6 times of that of the second sound cavity 16. By adjusting the ratio of the volumes of the first sound cavity 15 and the second sound cavity 16, the amplitude and phase of sounds emitted from the sound outlet hole 11 and the sound outlet hole 12 are adjusted.

Acoustic mesh clothes are also required to be attached to the channels of the sound outlet hole 11 and the reverse-phase sound hole 12, respectively, and impedance values of the mesh clothes are set according to actual needs. In some embodiments, the acoustic impedance formed by the sound outlet 11 and the acoustic mesh cloth is less than or equal to 9*10⁷ Pa·s/m³, and the acoustic impedance formed by the reverse-phase sound hole 12 and the acoustic mesh cloth is less than or equal to 9*10⁷ Pa·s/m³. The acoustic impedance K formed by the sound outlet hole 11 and the acoustic mesh cloth is a ratio of the acoustic damping value of the acoustic mesh cloth to the cross-sectional area of the sound outlet hole 11, i.e., K=the acoustic damping value of the acoustic mesh cloth/the cross-sectional area of the sound outlet hole.

The cross-sectional area of the sound outlet hole 11 is 20% to 35% of the area of a vibrating diaphragm of the sound source 20, and the cross-sectional area of the reverse-phase sound hole 12 is 15% to 20% of the area of the vibrating diaphragm of the sound source 20. The amplitude and phase of sound emitted from the sound outlet hole 11 may be adjusted by adjusting the area of the sound outlet hole 11. Shapes of the sound outlet hole 11 and the reverse-phase sound hole 12 are not limited to a circular shape or a square shape or an elliptical shape or a racetrack shape. Specifically, the vibrating diaphragm of the sound source 20 includes a first vibrating diaphragm 201A, a first vibrating diaphragm 201B, a second vibrating diaphragm 202B, a first vibrating diaphragm 201C, a passive vibrating diaphragm 107, a first vibrating diaphragm 201D, and a second vibrating diaphragm 202D, which are described below.

The sound outlet hole 11 is one or more than two in number, and the reverse-phase sound hole 12 is one or more than two in number, but the spatial positions of the sound outlet hole 11 and the reverse-phase sound hole 12 need to meet the definition of the present disclosure in the spatial coordinate system. In this embodiment, only one front sound outlet hole 11 and one reverse-phase hole 12 are used.

In some embodiments, the areas of the sound outlet hole 11 and the reverse-phase sound hole 12 are greater than or equal to 4 mm², and the area of the sound outlet hole 11 is 0.4 to 2.5 times of that of the reverse-phase sound hole 12. The areas of the sound outlet hole 11 and the reverse-phase sound hole 12 are greater than or equal to 4 mm², thereby avoiding the loss of sound intensity and suppressing high frequency sound. The area of the sound outlet hole 11 is 0.4 to 2.5 times of that of the reverse-phase sound hole 12, so that the amplitude and phase of sounds emitted from the sound outlet hole 11 and the reverse-phase sound hole 12 are adjusted by adjusting the ratio of the areas of the sound outlet hole 11 and the reverse-phase sound hole 12.

The cross-sectional area of the acoustic dipole tube 17 is greater than or equal to 2 mm². The length of the acoustic dipole tube 17 is greater than or equal to 2 mm and less than or equal to 25 mm. The volume of the acoustic dipole tube 17 is larger than or equal to 4 mm³ and less than or equal to 50 mm³. By adjusting the cross-sectional area, length and volume of the dipole tube, and matching with the structural size parameters of the first sound cavity 15 and the second sound cavity 16, the sound outlet hole 11 and the reverse-phase sound hole 12, and the first sound hole 171 and the second sound hole 172, the frequency range, amplitude, and sound-leakage frequency range of the low-frequency enhancement sound may be adjusted.

As shown in FIG. 5, the two end surfaces of the acoustic dipole tube 17 are located in the cavities where vibrating diaphragms of the sound source 20 are located, that is, the first sound hole 171 is located in the first sound cavity 15, and the second sound hole 172 is located in the second sound cavity 16. The distance d1 between the centers of the first sound hole 171 and the second sound hole 172, and the center of the corresponding vibrating diaphragm is not more than 25 mm, which effectively enhances the bass effect of the acoustic device, adjusts the amplitude and phase of sound emitted from the sound outlet hole 11 and the reverse-phase sound hole 12, effectively improves the sound coupling of the sound source 20, and reduces the sound leakage volume.

As shown in FIG. 5, the distance d2 between the center of the first sound hole 171 of the acoustic dipole tube 17 and the center of the sound outlet hole 11 is not more than 30 mm, and the distance d3 between the center of the second sound hole 172 and the center of the reverse-phase sound hole 12 is not more than 30 mm, so as to improve the low-frequency effect of the acoustic device.

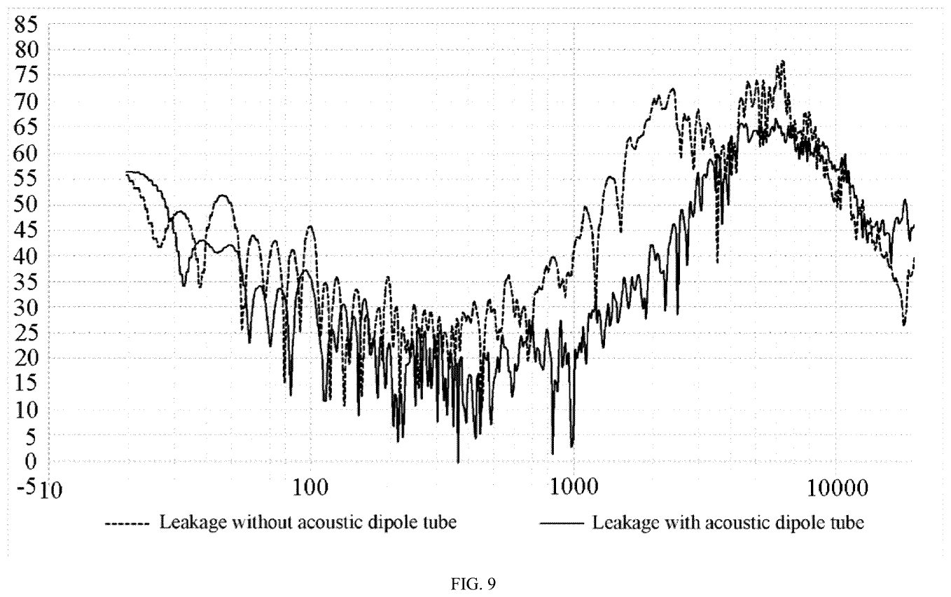

Specifically, as shown in the sound-leakage frequency response curve of FIG. 9, the horizontal axis indicates frequencies (unit: Hz), and the vertical axis indicates sound pressure levels (unit: dB). The sound-leakage curve is obtained under the condition that a tested microphone is 0.5 m away from this acoustic device, that is, the sound leakage condition is tested through a microphone at a position 0.5 m away from this acoustic device. Under the same test conditions, the sound-leakage frequency response curve of the acoustic device having the acoustic dipole tube 17 is shown by a solid line, and the sound-leakage frequency response curve of the acoustic device having no acoustic dipole tube 17 is shown by a broken line. It can be seen from the figure that when sound emitted by the acoustic device is less than 350 Hz, the presence or absence of the acoustic dipole tube 17 does not have a significant effect on the sound leakage. When sound emitted by the acoustic device is between 350 Hz and 8000 Hz, the sound pressure level generated by the acoustic device having the acoustic dipole tube 17 is much less than that generated by the acoustic device having no acoustic dipole tube 17 at the same sound frequency, which indicates that the acoustic device having the acoustic dipole tube 17 has smaller sound leakage and thus can improve the privacy protection of users.

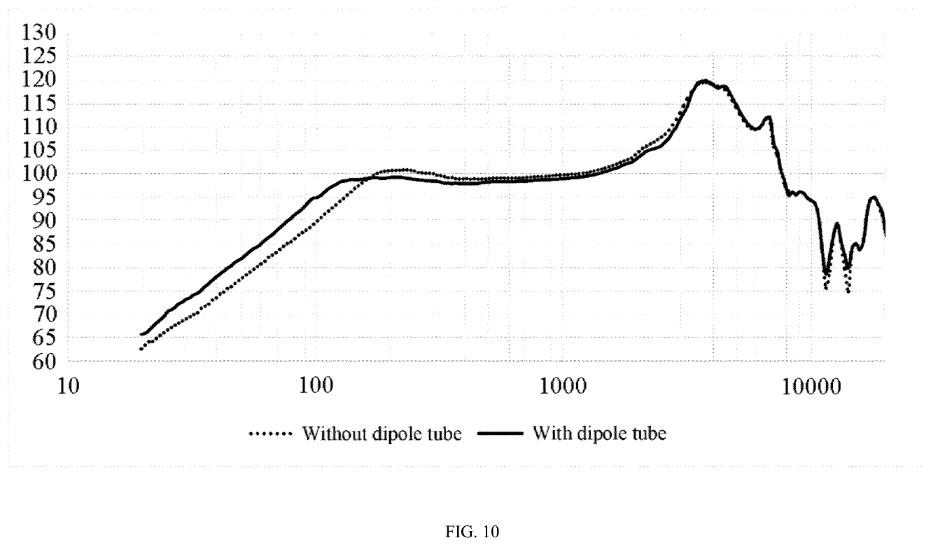

Specifically, as shown in the frequency response curve of FIG. 10, the horizontal axis indicates frequencies (unit: Hz), and the vertical axis indicates sound pressure levels (unit: dB). The frequency response curves of the acoustic devices on a simulated human ear are shown respectively in a broken line for the acoustic device having no acoustic dipole tube 17, and in a solid line for the acoustic device having the acoustic dipole tube 17. Compared with the broken line, the solid line extends to the low frequency band to improve the sound pressure level of the low frequency, so that human ear can hear more details of low frequency sound and improve the low frequency performance of the acoustic device.

In the actual design process, a single-vibrating diaphragm loudspeaker, a double-vibrating diaphragm loudspeaker, a combination of the single-vibrating diaphragm loudspeaker and a passive vibrating diaphragm, and a loudspeaker assembly formed by at least one pair of single-vibrating diaphragm loudspeakers may be adopted for the sound source 20.

When the sound source 20 adopts a single-vibrating diaphragm loudspeaker, as shown in FIG. 5, the single-vibrating diaphragm loudspeaker is provided with a first vibrating diaphragm 201A. The housing 10 includes a first surface 101, a second surface 102, and a side surface 103 connecting the first surface 101 and the second surface 102. A first mounting surface 104 for fixing the sound source 20 is provided inside the housing 10. The first mounting surface 104, the first vibrating diaphragm 201A, and an inner wall of the housing 10 are sealed to form the first sound cavity 15. In this structure, the sound outlet hole 11 is provided in the first surface 101. However, the sound outlet hole 11 may be provided in the second surface 102 or the side surface 103 as required in applications. A bracket 106 for fixing the speaker is disposed inside the housing 10. Specifically, the first mounting surface 104 is an end surface of the bracket 106. The single-vibrating diaphragm loudspeaker is in sealed connection with the bracket 106, or the first vibrating diaphragm 201A is in sealed connection with the first mounting surface 104, so that the front side and the rear side of the single-vibrating diaphragm loudspeaker are isolated from each other. Therefore, the second sound cavity 16 is formed between the rear side of the single-vibrating diaphragm loudspeaker and an inner wall of the housing 10. Similarly, in this structure, the position of the reverse-phase sound hole 12 communicating with the second sound cavity 16 is located in the second surface 102. According to actual applications, the position of the reverse-phase sound hole 12 may be provided in the side surface 103 and the first surface 101. The first sound cavity 15 and the second sound cavity 16 are communicated through the acoustic dipole tube 17, and specifically, the acoustic dipole tube 17 is provided at one side of the single-vibrating diaphragm loudspeaker.

Specifically, the first sound hole 171 is disposed in the first sound cavity 15 and the second sound hole 172 is disposed in the second sound cavity 16, the first sound hole 171 is communicated with and the second sound hole 172 through the acoustic dipole tube 17, and the first sound hole 171 and the second sound hole 172 are end surfaces of the acoustic dipole tube, so that the first sound cavity 15 and the second sound cavity 16 are communicated with each other. The first sound cavity 15 and the second sound cavity 16 are communicated through the acoustic dipole tube 17, so that sounds with identical amplitudes and opposite phases are coupled in the housing 10. By adjusting the size of the acoustic dipole tube 17 and the damping values of the acoustic mesh clothes disposed on the acoustic dipole tube 17, the purpose of adjusting the acoustic coupling is achieved, thereby effectively suppressing the sound leakage. The acoustic mesh clothes on the acoustic dipole tube 17 are generally disposed on the first sound hole 171 and the second sound hole 172. By adjusting the damping values of the mesh clothes of the first sound hole 171 and the second sound hole 172 and adjusting the damping values of the acoustic mesh clothes of the first sound hole 171 and the second sound hole 172 in cooperation, the cut-off frequency of low-frequency sound of the device can be moved to the bass, so as to enhance the bass.

In some embodiments, the acoustic impedances formed by the first sound hole 171 and the second sound hole 172 and the acoustic mesh clothes attached thereto are less than or equal to 9*10⁷ Pa·s/m³.

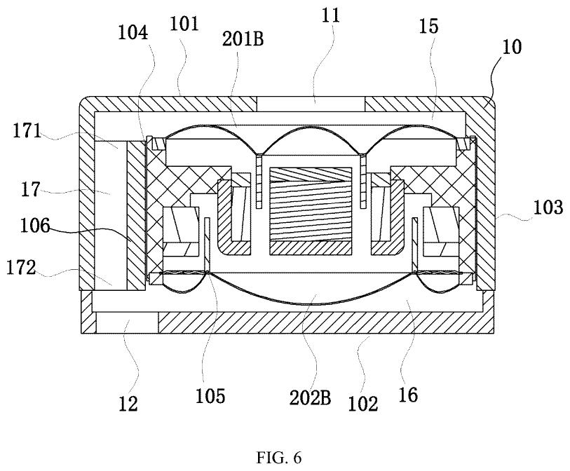

When the sound source 20 adopts a dual-vibrating diaphragm loudspeaker, as shown in FIG. 6, the dual-vibrating diaphragm loudspeaker is provided with a first vibrating diaphragm 201B and a second vibrating diaphragm 202B. The first vibrating diaphragm 201B and the second vibrating diaphragm 202B are disposed on both sides of the loudspeaker, respectively. The housing structure is the same as the housing 10 for the single-vibrating diaphragm loudspeaker, and is not repeated herein. The dual-vibrating diaphragm loudspeaker is mounted on the bracket 106, and the dual-vibrating diaphragm loudspeaker is in sealed connection with the bracket 106, so that the front side and the rear side of the dual-vibrating diaphragm loudspeaker are sealed from each other. One end surface of the bracket 106 facing the sound outlet hole 11 is a first mounting surface 104, and the other end surface of the bracket 106 facing the reverse-phase sound hole 12 is a second mounting surface 105, so the dual-vibrating diaphragm loudspeaker is in sealed connection with the first mounting surface 104 and the second mounting surface 105, or, the first vibrating diaphragm 201B and the second vibrating diaphragm 202B are in sealed connection with the first mounting surface 104 and the second mounting surface 105, so that the front side and the rear end of the dual-vibrating diaphragm speak are sealed and isolated from each other.

The first mounting surface 104, the first vibrating diaphragm 201B, and the inner wall of the housing 10 are sealed to form the first sound cavity 15. In this structure, the sound outlet hole 11 is provided in the first surface 101, but the sound outlet hole 11 may be provided in the second surface 102 or the side surfaces 103, as required in applications. The second sound cavity 16 is formed between the second mounting surface 105, the second vibrating diaphragm 202B, and the inner wall of the housing 10. Similarly, in this structure, the position of the reverse-phase sound hole 12 communicating with the second sound cavity 16 is located in the second surface 102. However, according to actual applications, the position of the reverse-phase sound hole 12 may be located in the side surface 103 and the first surface 101. The first sound cavity 15 and the second sound cavity 16 are communicated through the acoustic dipole tube 17, and specifically, the acoustic dipole tube 17 is provided at one side of the dual-vibrating diaphragm loudspeaker.

The first sound cavity 15 and the second sound cavity 16 are communicated through the acoustic dipole tube 17, so that sounds with identical amplitudes and opposite phases are coupled in the housing 10. By adjusting the size of the acoustic dipole tube 17 and the damping values of the acoustic mesh clothes disposed on the acoustic dipole tube 17, the purpose of adjusting the acoustic coupling is achieved, thereby effectively suppressing the sound leakage. The acoustic mesh clothes on the acoustic dipole tube 17 are generally disposed on the first sound hole 171 and the second sound hole 172. By adjusting the damping values of the mesh clothes of the first sound hole 171 and the second sound hole 172, the cut-off frequency of low-frequency sound of the device can be moved to the bass, so as to enhance the bass.

A sealed cavity is formed between the first vibrating diaphragm 201B and the second vibrating diaphragm 202B of the dual-vibrating diaphragm loudspeaker and inside the loudspeaker, and the volume of the sealed cavity is less than 8 cm³, so that the first vibrating diaphragm 201B and the second vibrating diaphragm 202B are in effective coupled vibration to better adjust the amplitude and phase of sounds emitted from the sound outlet hole 11 and the reverse-phase sound hole 12.

In some embodiments, the acoustic impedances formed by the first sound hole 171 and the second sound hole 172 and the acoustic mesh clothes attached thereto are less than or equal to 9*10⁷ Pa·s/m³.

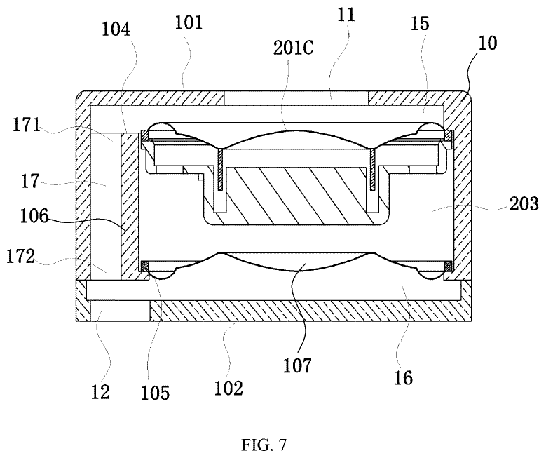

When the sound source 20 adopts a combination of a single-vibrating diaphragm loudspeaker and a passive diaphragm, as shown in FIG. 7, the single-vibrating diaphragm loudspeaker is provided with a first vibrating diaphragm 201C and the passive diaphragm 107 is fixed to the bracket 106 and located at the rear side of the single-vibrating diaphragm loudspeaker. The housing structure is the same as the housing 10 for the single-vibrating diaphragm loudspeaker, and is not repeated herein. One end surface of the bracket 106 facing the sound outlet hole 11 is the first mounting surface 104, and the other end surface of the bracket 106 facing the reverse-phase sound hole 12 is the second mounting surface 105. Therefore, the single-vibrating diaphragm loudspeaker is in sealed connection with the first mounting surface 104, or, the first vibrating diaphragm 201C is in sealed connection with the first mounting surface 104, so that the front side and the rear end of the single-vibrating diaphragm speak are sealed and isolated from each other. In addition, the passive vibrating diaphragm 107 is sealed and fixed on the second mounting surface 105, so that the passive vibrating diaphragm 107 and the rear side of the single-vibrating diaphragm loudspeaker form a first closed sound cavity 203. In some embodiments, the center distance between the first vibrating diaphragm 201C and the passive vibrating diaphragm 107 is not more than 25 mm, and the volume of the first closed sound cavity 203 is less than 18 cm³. Vibration information of the first vibrating diaphragm 201C is subjected to coupled through an air hole in the single-vibrating diaphragm loudspeaker and the first closed sound cavity 203, so that sounds emitted from the sound outlet hole 11 and the sound reverse-phase hole 12 have opposite phases and identical amplitudes.

The first mounting surface 104, the first vibrating diaphragm 201C, and the inner wall of the housing 10 are sealed to form the first sound cavity 15. In this structure, the sound outlet hole 11 is provided in the first surface 101, but the sound outlet hole 11 may be provided in the second surface 102 or the side surfaces 103, as required in applications. The second sound cavity 16 is formed between the second mounting surface 105, the passive vibrating diaphragm 107, and the inner wall of the housing 10. Similarly, in this structure, the position of the reverse-phase sound hole 12 communicating with the second sound cavity 16 is located in the second surface 102. According to actual applications, the position of the reverse-phase sound hole 12 may be located in the side surface 103 and the first surface 101. The first sound cavity 15 and the second sound cavity 16 are communicated through the acoustic dipole tube 17, and specifically, the acoustic dipole tube 17 is provided at one side of the single-vibrating diaphragm loudspeaker.

In some embodiments, the acoustic impedances formed by the first sound hole 171 and the second sound hole 172 and the acoustic mesh clothes attached thereto are less than or equal to 9*10⁷ Pa·s/m³.

The first sound cavity 15 and the second sound cavity 16 are communicated through the acoustic dipole tube 17, so that sounds with identical amplitudes and opposite phases are coupled in the housing 10. By adjusting the size of the acoustic dipole tube 17 and the damping values of the acoustic mesh clothes disposed on the acoustic dipole tube 17, the purpose of adjusting the acoustic coupling is achieved, thereby effectively suppressing the sound leakage. The acoustic mesh clothes on the acoustic dipole tube 17 are generally disposed on the first sound hole 171 and the second sound hole 172. By adjusting the damping values of the mesh clothes of the first sound hole 171 and the second sound hole 172, the cut-off frequency of low-frequency sound of the device can be moved to the bass, so as to enhance the bass.

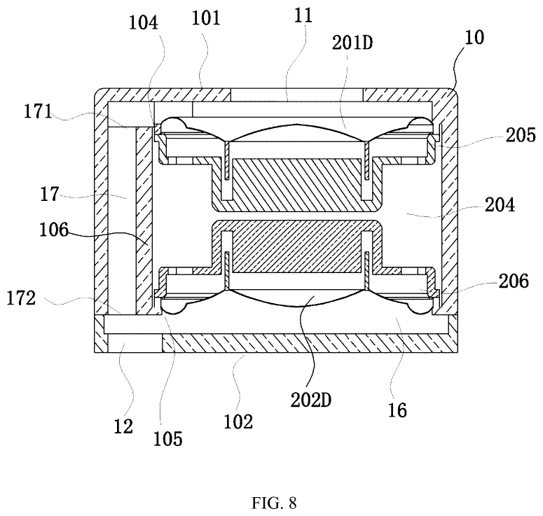

The sound source 20 adopts a loudspeaker assembly formed by at least one pair of single-vibrating diaphragm loudspeakers, as shown in FIG. 8. The loudspeaker assembly is at least one pair of single-vibrating diaphragm loudspeakers installed opposite to each other, one of which is a first loudspeaker 205 with a vibrating diaphragm facing the sound outlet hole 11 and called as a first vibrating diaphragm 201D, and, the other of which is a first loudspeaker 206 with a vibrating diaphragm facing the reverse-phase sound hole 12 and called as a second vibrating diaphragm 202D. The center distance between the first vibrating diaphragm 201D and the second vibrating diaphragm 202D is not more than 25 mm. The housing structure is the same as the housing 10 for the single-vibrating diaphragm loudspeaker, and the bracket 106 is the same as the bracket for the single-vibrating diaphragm loudspeaker, which is not repeated herein. A rear side of that first loudspeaker 205 and a rear side of the first loudspeaker 206 form a second closed sound cavity 204. In some embodiments, the volume of the second closed sound cavity 204 is less than 18 cm³. The first loudspeaker 205 and the first loudspeaker 206 are controlled by an input electrical signal so that sounds emitted from the first vibrating diaphragm 201D and from the second vibrating diaphragm 202D have identical amplitudes and opposite phases.

The first vibrating diaphragm 201D, the first mounting surface 104, and the inner wall of the housing 10 are sealed to form the first sound cavity 15. In this structure, the sound outlet hole 11 is provided in the first surface 101, but the sound outlet hole 11 may be provided in the second surface 102 or the side surfaces 103, as required in applications. The second sound cavity 16 is formed between the second mounting surface 105, the second vibrating diaphragm 202D, and the inner wall of the housing 10. Similarly, in this structure, the position of the reverse-phase sound hole 12 communicating with the second sound cavity 16 is located in the second surface 102. However, according to actual applications, the position of the reverse-phase sound hole 12 may be located in the side surface 103 and the first surface 101. The first sound cavity 15 and the second sound cavity 16 are communicated through the acoustic dipole tube 17, and specifically, the acoustic dipole tube 17 is provided at one side of the single-vibrating diaphragm loudspeaker.

Similarly, the first sound cavity 15 and the second sound cavity 16 are communicated through the acoustic dipole tube 17, so that sounds with identical amplitudes and opposite phases are coupled in the housing 10. By adjusting the size of the acoustic dipole tube 17 and the damping values of the acoustic mesh clothes disposed on the acoustic dipole tube 17, the purpose of adjusting the acoustic coupling is achieved, thereby effectively suppressing the sound leakage. The acoustic mesh clothes on the acoustic dipole tube 17 are generally disposed on the first sound hole 171 and the second sound hole 172. By adjusting the damping values of the mesh clothes of the first sound hole 171 and the second sound hole 172, the cut-off frequency of low-frequency sound of the device can be moved to the bass, so as to enhance the bass.

In some embodiments, the acoustic impedances formed by the first sound hole 171 and the second sound hole 172 and the acoustic mesh clothes attached thereto are less than or equal to 9*10⁷ Pa·s/m³.

Compared with the prior art, according to the present disclosure, the first sound cavity 15 is provided between the sound outlet hole 11 and the sound source, the second sound cavity 16 is provided between the reverse-phase sound hole 16 and the rear side of the sound source, and the first sound cavity 15 is communicated with the second sound cavity 16 through the acoustic dipole tube 17, such that sounds with identical amplitudes and opposite phases are coupled inside the acoustic device, and the size of the acoustic dipole tube and acoustic impedances provided on the acoustic dipole tube are adjusted so as to achieve the purpose of adjusting the size of sound coupling, thereby effectively inhibiting sound leakage.

The technical content of the present disclosure is further described above only by way of embodiments so as to facilitate readers to understand more easily. However, it does not mean that embodiments of the present disclosure are limited thereto. Any technical extension or recreation according to the present disclosure is protected by the present disclosure. The scope of the present disclosure is defined by the claims.

What is claimed is:

1. An acoustic device, comprising a housing and a sound source disposed in the housing, wherein the housing is provided with a sound outlet hole and a reverse-phase sound hole in different surfaces of the housing; sounds emitted from the sound outlet hole and from the reverse-phase sound hole are opposite in phase and identical in amplitude; a first sound cavity is formed between a front end of the sound source and the sound outlet hole, and a second sound cavity is formed between a rear end of the sound source and the reverse-phase sound hole; and the first sound cavity is communicated with the second sound cavity through an acoustic dipole tube.

2. The acoustic device according to claim 1, wherein the sound source radiates sound signals to a front side and a rear side of the sound source.

3. The acoustic device according to claim 1, wherein a spatial coordinate system is established with Ear canal Entrance Point, EEP, in Standard ITU-T P.57, as an origin point, the EEP is provided as the origin point 0, a positive semi-axis of X axis that is perpendicular to an ear outwardly is provided, a positive semi-axis of Y axis that is perpendicular to the ear forwardly is provided, and a positive semi-axis of Z axis that is vertical upwardly is provided; when the acoustic device is worn, the sound outlet hole is located in an area of (0 mm, −12.2 mm, −5.2 mm), (15.3 mm, 3.2 mm, 13.3 mm) and (3 mm, 10 mm, −10 mm) in the coordinate system, and the reverse-phase sound hole is located in an area of (5 mm, −22 mm, −3.2 mm), (27.3 mm, 15 mm, 18 mm) and (5 mm, −15 mm, 12 mm) in the coordinate system.

4. The acoustic device according to claim 1, wherein a spatial coordinate system is established with Ear reference Point, EPR, in Standard ITU-T P.57, as an origin point, the EPR is provided as the origin point 0, a positive semi-axis of X axis that is perpendicular to an ear outwardly is provided, a positive semi-axis of Y axis that is perpendicular to the ear forwardly is provided, and a positive semi-axis of Z axis that is vertical upwardly is provided; when the acoustic device is worn, the sound outlet hole is located in an area of (0 mm, −12.2 mm, −5.2 mm), (15.3 mm, 3.2 mm, 13.3 mm) and (3 mm, 10 mm, −10 mm) in the coordinate system, and the reverse-phase sound hole is located in an area of (5 mm, −22 mm, −3.2 mm), (27.3 mm, 15 mm, 18 mm) and (5 mm, −15 mm, 12 mm) in the coordinate system.

5. The acoustic device according to claim 1, wherein a set angle is formed between a sound outlet direction of the sound outlet hole and a sound outlet direction of the reverse-phase sound hole, and the set angle is 90° to 180°.

6. The acoustic device according to claim 1, wherein volumes of the first sound cavity and the second sound cavity are both greater than 0.8 cm³, and the volume of the first sound cavity is 0.4 to 6 times that of the second sound cavity.

7. The acoustic device according to claim 1, wherein the sound outlet hole and the reverse-phase sound hole are both provided with acoustic mesh clothes, respectively, and an acoustic impedance of the sound outlet hole and the corresponding acoustic mesh cloth, and an acoustic impedance of the reverse-phase sound hole and the corresponding acoustic mesh cloth are less than or equal to 9*107 Pa·s/m³.

8. The acoustic device according to claim 1, wherein a cross-sectional area of the sound outlet hole is 20% to 35% of an area of a vibrating diaphragm of the sound source, and a cross-sectional area of the reverse-phase sound hole is 15% to 20% of the area of the vibrating diaphragm of the sound source.

9. The acoustic device according to claim 1, wherein areas of the sound outlet hole and the reverse-phase sound hole are both greater than or equal to 4 mm², and the area of the sound outlet hole is 0.4 to 2.5 times that of the reverse-phase sound hole.

10. The acoustic device according to claim 1, wherein a cross-sectional area of the acoustic dipole tube is greater than or equal to 2 mm², and a length of the acoustic dipole tube is greater than or equal to 2 mm and less than or equal to 25 mm.

11. The acoustic device according to claim 1, wherein the acoustic dipole tube is provided with an acoustic mesh cloth at a position where the first sound cavity or the second sound cavity is communicated with the acoustic dipole tube; and an acoustic impedance formed by the acoustic dipole tube and the corresponding acoustic mesh cloth is less than or equal to 9*107 Pa·s/m³.

12. The acoustic device according to claim 1, wherein the sound source is a single-vibrating diaphragm loudspeaker; the single-vibrating diaphragm loudspeaker is provided with a first vibrating diaphragm; the first sound cavity is formed between the first vibrating diaphragm and an inner wall of the housing; and the second sound cavity is formed between a rear side of the single-vibrating diaphragm loudspeaker and an inner wall of the housing.

13. The acoustic device according to claim 1, wherein the sound source is a dual-vibrating diaphragm loudspeaker; the dual-vibrating diaphragm loudspeaker is provided with a first vibrating diaphragm and a second vibrating diaphragm; the first sound cavity is formed between the first vibrating diaphragm and an inner wall of the housing; and the second sound cavity is formed between the second vibrating diaphragm and an inner wall of the housing.

14. The acoustic device according to claim 1, wherein the sound source comprises a single-vibrating diaphragm loudspeaker and a passive vibrating diaphragm; the single-vibrating diaphragm loudspeaker is provided with a first vibrating diaphragm; the first sound cavity is formed between the first vibrating diaphragm and an inner wall of the housing; and the second sound cavity is formed between the passive vibrating diaphragm and an inner wall of the housing.

15. The acoustic device according to claim 14, wherein the passive vibrating diaphragm and a rear side of the single-vibrating diaphragm loudspeaker form a first closed sound cavity; and a volume of the first closed sound cavity is less than 18 cm³.

16. The acoustic device according to claim 1, wherein the sound source is a loudspeaker assembly; the loudspeaker assembly comprises at least one pair of single-vibrating diaphragm loudspeakers; the single-vibrating diaphragm loudspeakers are disposed back to back; the single-vibrating diaphragm loudspeakers are provided with first vibrating diaphragms, respectively; the first sound cavity is formed between the first vibrating diaphragm of one single-vibrating diaphragm loudspeaker and an inner wall of the housing, and the second sound cavity is formed between the first vibrating diaphragm of the other single-vibrating diaphragm loudspeaker and an inner wall of the housing.

17. The acoustic device according to claim 16, wherein a second closed sound cavity is formed between rear sides of the pair of single-vibrating diaphragm loudspeakers; and a volume of the second closed sound cavity is less than 18 cm³.

18. The acoustic device according to claim 1, wherein the sound source is provided with a vibrating diaphragm, and a distance between a center of two ends of the acoustic dipole tube and a center of the vibrating diaphragm is not more than 25 mm.

19. The acoustic device according to claim 1, wherein a distance between a center of two ends of the acoustic dipole tube and a center of the sound outlet hole and a distance between the center of two ends of the acoustic dipole tube and a center of the reverse-phase sound hole are both not more than 30 mm.
